(19) United States
(12) Patent Application Publication
(10) Pub. No.: US 2005/0193544 A1
(43) Pub. Date: Sep. 8, 2005

(54) Weatherstrip applicator head

(76) Inventors: Andrew B. Supina, Lake Elmo, MN (US); Mark J. Zach, Northfield, MN (US); Thomas P. Wallisch, St. Paul, MN (US); Jack L. Perecman, Golden Valley, MN (US); Todd A. Pesek, Cottage Grove, MN (US); Jeffery A. Barrett, Forest Lake, MN (US)

Correspondence Address: 3M INNOVATIVE PROPERTIES COMPANY, PO BOX 33427, ST. PAUL, MN, 55133-3427, US

(21) Appl. No.: 11/070,675

(22) Filed: Mar. 2, 2005

Related U.S. Application Data
(60) Provisional application No. 60/549,849, filed on Mar. 3, 2004.

(51) Int. Cl. B60J 1/16; E05F 11/38

(52) U.S. Cl. 29/450; 49/451

(57) ABSTRACT

A device and method for applying a segment of weatherstrip includes advancing a continuous supply of weatherstrip to a cutting station. The weatherstrip has a face at least partially covered with an adhesive and a removable liner attached to the adhesive on the face. A first portion of the weatherstrip is positioned upstream of a cutting station and a second portion is positioned downstream of the cutting station. The liner is removed from the first portion of the weatherstrip prior to the weatherstrip advancing into the cutting station to define a loop of removed liner section, and a portion of the removed liner section is attached to the second portion of the weatherstrip, thereby defining a reapplied liner section on the second portion of the weatherstrip. The advance of the weatherstrip past the cutting station is stopped and the weatherstrip is cut at the cutting station proximate a cut point to define an individual segment of weatherstrip with adhesive thereon. The reapplied liner section is drawn away from the cutting station, thereby pulling the weatherstrip segment to a lay down assembly while the advance of the first portion of the weatherstrip remains stopped. The reapplied liner section is then removed from the weatherstrip segment.

This application claims priority to U.S. Provisional Application No. 60/549,849, filed Mar. 3, 2004, and International Application No. PCT/US04/17386, filed Jun. 1, 2004, which claims the benefit under 35 U.S.C. § 119(e) of U.S. Provisional Application 60/474,987, filed Jun. 2, 2003.

### FIELD OF THE INVENTION

The present invention relates to a device for applying a weatherstrip seal, in particular, to a device for applying an adhesive tape-applied weatherstrip seal, and also to a process for applying a length of tape-applied weatherstrip seal to a substrate or a peripheral edge of a body or structure defining an opening (e.g., a vehicle door or door frame of a vehicle body such as an automobile, aircraft or watercraft body), and in particular, to such a process that includes advancing a finite or continuous length of tape-applied weatherstrip seal through an applicator head or end effector.

### BACKGROUND OF THE INVENTION

Rubber or other elastomeric profiles are known for making waterproof and/or airtight seals, for example, for use on automobile doors and refrigerator doors. Such elastomeric profiles are commonly provided in a closed-loop format, or of a discrete length, or in a continuous roll and often have at least one heat-formed or molded corner. Each elastomeric profile, or weatherstrip, is specifically designed and manufactured for each door type or each specific substrate to be sealed.

Commonly, the weatherstrips are attached to an opening to be sealed using mechanical interlocking techniques where the profile engages a groove or a lip in the door opening or on the door itself. Alternatively, the elastomeric profiles may be attached using other mechanical means such as pins. Elastomeric profiles may also be glued into place, and can be attached to a car door or door opening using pressure-sensitive adhesive tapes. Tapes especially suited for adhering rubber or other elastomeric profiles used as seals in automotive door or trunk opening are available from 3M Company (3M Deutschland GmbH in Neuss, Germany). Examples include a dual functional adhesive tape with a heat-activated adhesive on one side for bonding to the elastomeric profiles and a tacky pressure-sensitive adhesive on the other side for adhering the taped elastomeric profiles to a door opening, or a tape including a pressure-sensitive adhesive on each. The particular tape selected depends on the substrates to which the elastomeric profile is to be bonded.

Robotic end effector tooling is known for mechanically installing a closed-loop of weatherstrip to a lip surrounding a vehicle opening. Typically, the apparatus comprises means for feeding the weatherstrip to the end effector, a plurality of guide rollers to form the length of weatherstrip into a loop, and a plurality of arms for pressing the weatherstrip onto a lip of an opening. End effector tooling, or applicator heads, have also been disclosed that facilitate installation of adhesive based weatherstripping to a vehicle opening.

An improved process is desired in the art for advancing a continuous roll of tape-applied weatherstrip through an end effector, cutting an individual length of weatherstrip, applying the length of weatherstrip to a vehicle door or door frame, and in addition, advancing the weatherstrip through the end effector.

### SUMMARY OF THE INVENTION

The present invention is directed to a method for applying an individual segment of weatherstrip. A continuous supply of weatherstrip is advanced to a cutting station, whereby the weatherstrip has a three dimensional profile with a face at least partially covered with an adhesive and a removable liner attached to the adhesive on the face. A first portion of the weatherstrip is positioned upstream of the cutting station and a second portion is positioned downstream of the cutting station. The liner is removed from the first portion of the weatherstrip, prior to the weatherstrip advancing into the cutting station, to define a loop of removed liner section. A portion of the removed liner section is attached to the second portion of the weatherstrip by engaging the portion of the removed liner section through adhesive on the face of the profile on the weatherstrip, thereby defining a reapplied liner section on the second portion of the weatherstrip. Once the advance of the weatherstrip past the cutting station is stopped, the weatherstrip is cut at the cutting station proximate a cut point separating the first portion and the second portion of the weatherstrip to define an individual segment of weatherstrip with adhesive thereon from the second portion of the weatherstrip. The reapplied liner section is drawn away from the cutting station, thereby pulling the weatherstrip segment to a lay down assembly while the advance of the first portion of the weatherstrip remains stopped. The reapplied liner section is then removed from the weatherstrip segment.

In addition, the present invention includes using the lay down assembly to adhere the weatherstrip segment to a substrate, such as a door frame or body of an automobile, using an adhesive on the face. All these steps are repeated to form a plurality of individual weatherstrip segments whereby each segment is applied to a substrate.

### BRIEF DESCRIPTION OF THE DRAWINGS

The present invention will be further explained with reference to the attached figures, wherein like structure is referred to by like numerals throughout the several views.

FIG. 1 is a front perspective view of a weatherstrip applicator head.

FIG. 2 is a side view of the weatherstrip applicator head.

FIG. 3 is a rear perspective view of the weatherstrip applicator head.

FIG. 4 is a bottom perspective view of the weatherstrip applicator head.

FIG. 5 is a cross-section of a portion of a weatherstrip.

FIGS. 6-13 are schematic diagrams illustrating a process for attaching a piece of weatherstrip from a supply roll to a substrate.

While the above-identified drawing figures set forth one embodiment of the invention, other embodiments are also contemplated, as noted in the discussion. In all cases, this disclosure presents the present invention by way of representation and not limitation. It should be understood that numerous other modifications and embodiments can be devised by those skilled in the art which fall within the scope and spirit of the principles of this invention.

### DETAILED DESCRIPTION OF THE INVENTION

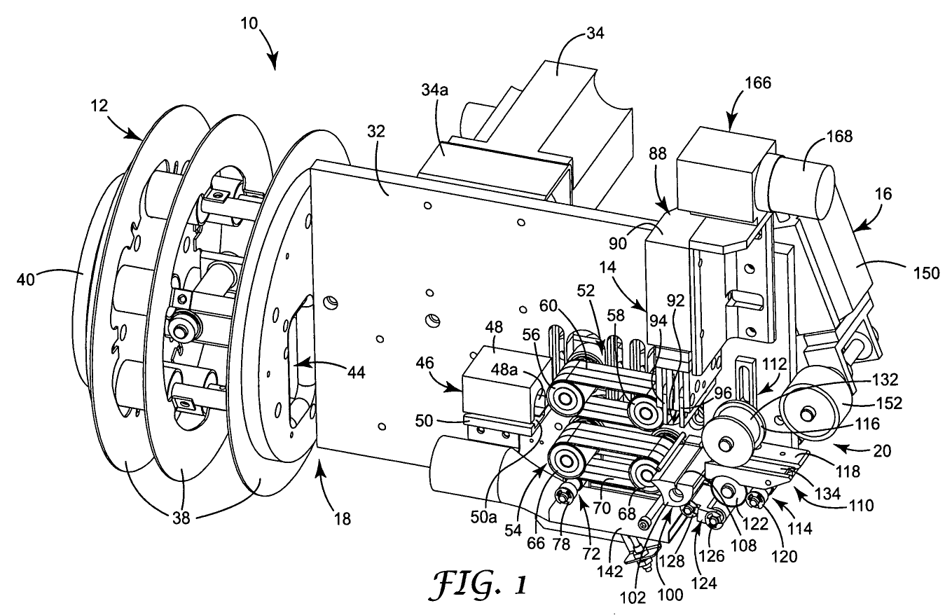

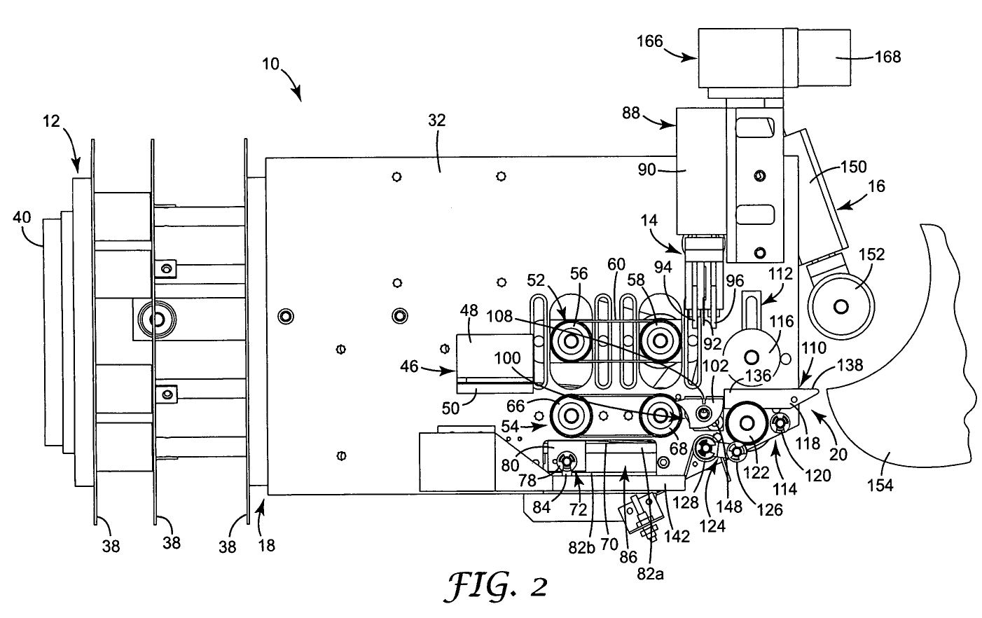

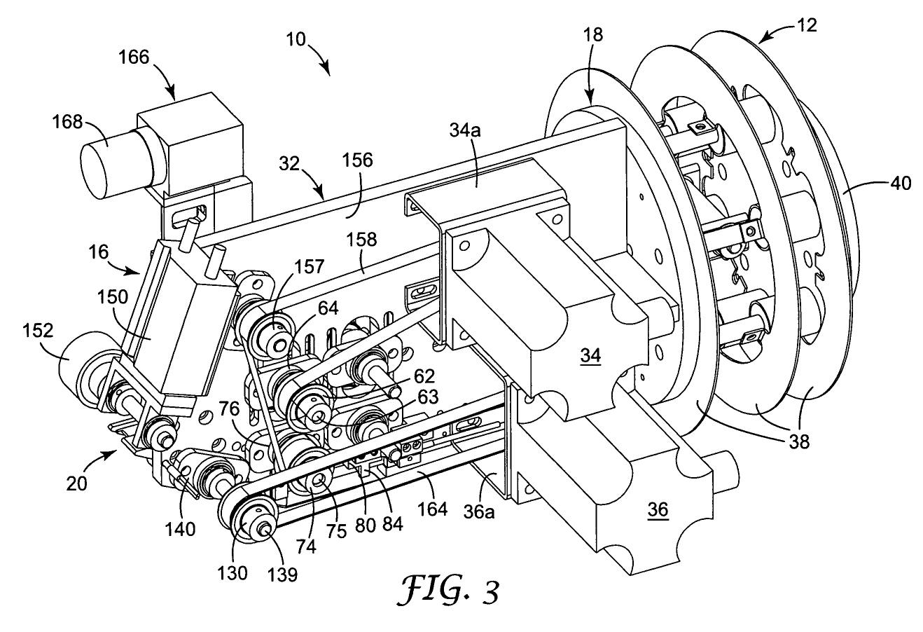

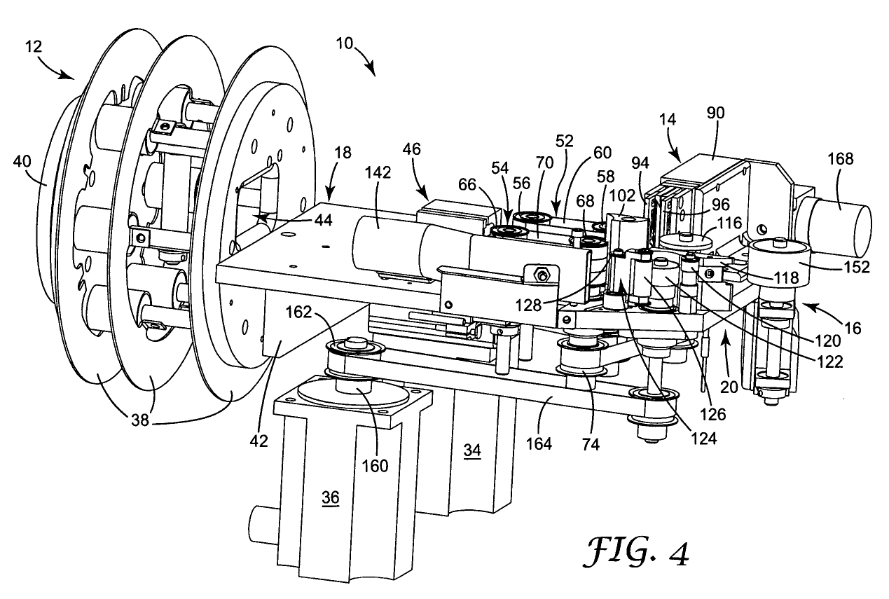

A weatherstrip applicator head 10, or end effector apparatus, is shown in FIGS. 1, 2, 3 and 4. FIG. 1 is a front perspective view of the weatherstrip applicator head 10, FIG. 2 is a side view of the weatherstrip applicator head 10, FIG. 3 is a rear perspective view of the weatherstrip applicator head 10, and FIG. 4 is a bottom perspective view of the weatherstrip applicator head 10. The applicator head includes a robot mounting assembly 12 for mounting the applicator head to a robot arm (not shown), a cutting station 14 to cut a continuous length of tape-applied weatherstrip (not shown) into an individual segment of weatherstrip, and a lay down assembly 16 to attach the individual segment of weatherstrip to a substrate, such as a peripheral edge of an opening or body (e.g., a vehicle door opening), or a vehicle door.

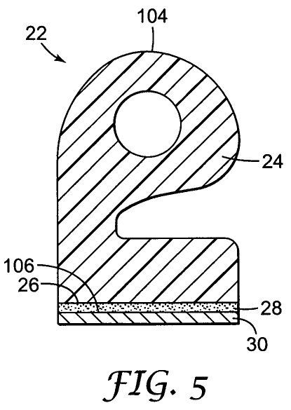

The applicator head 10 includes a feed end 18 and a discharge end 20. A length of material 22 (a cross-sectional example is shown in FIG. 5), comprised of a pliable, three dimensional profile 24 with a face 26 at least partially coated with an adhesive 28 and a removable liner 30 attached to the adhesive 28, enters the applicator head 10 at the feed end 18 and is cut into an individual segment of weatherstrip in the cutting station 14 before the weatherstrip segment is discharged from the applicator head 10 at the discharge end 20.

The applicator head 10 includes a back plate 32 defining a center wall, or center frame, of the applicator head 10. The robot mounting assembly 12 is positioned at the free end 18 of the applicator head 10, whereas the lay down assembly 16 is positioned at the discharge end 20 of the applicator head 10. The cutting station 14 is mounted to the back plate 32 and is positioned between the robot mounting assembly 12 and the lay down assembly 16. The applicator head 10 includes a pair of servo motors 34 and 36, shown attached to the back plate 32 in FIG. 3, to control advancement of the weatherstrip 22 to the cutting station 14 and to discharge of the weatherstrip segment from the applicator head 10. The applicator head 10 is configured to allow for quick changeover of components to minimize production downtime.

An example of the weatherstrip 22 is shown in FIG. 5, which is a cross-section of a portion of the weatherstrip 22. The weatherstrip 22 includes the three-dimensional profile 24, comprised of a pliable material such as rubber or other such elastomeric material, with the face 26 at least partially coated with the adhesive 28 and the removable liner 30 attached to the face 26 with the adhesive 28. The weatherstrip profile is typically formed from a dual-durometer rubber with a dense, high-durometer foot and a pliable bulb, such as EPDM, neoprene, or the like. The profile 24 typically has a single slot or a double slot design. Adhesive 28 and liner 30 may be provided as a tape especially suited for adhering elastomeric profiles used as seals. Such tapes are available from 3M Company (3M Deutschland GmbH in Neuss, Germany), and include 5402 ACRYLIC FOAM TAPE and 5608 ACRYLIC FOAM TAPE, which are dual functional adhesive tapes with a heat-activated adhesive on one side for bonding to the profile 24 and a tacky pressure-sensitive adhesive on the other side for adhering the weatherstrip to a substrate. The removable release liner 30 adheres to the pressure-sensitive adhesive and may be formed from a silicon coated polyethylene, which has a low adhesion to facilitate stripping the liner 30 off the adhesive face of the adhesive layer.

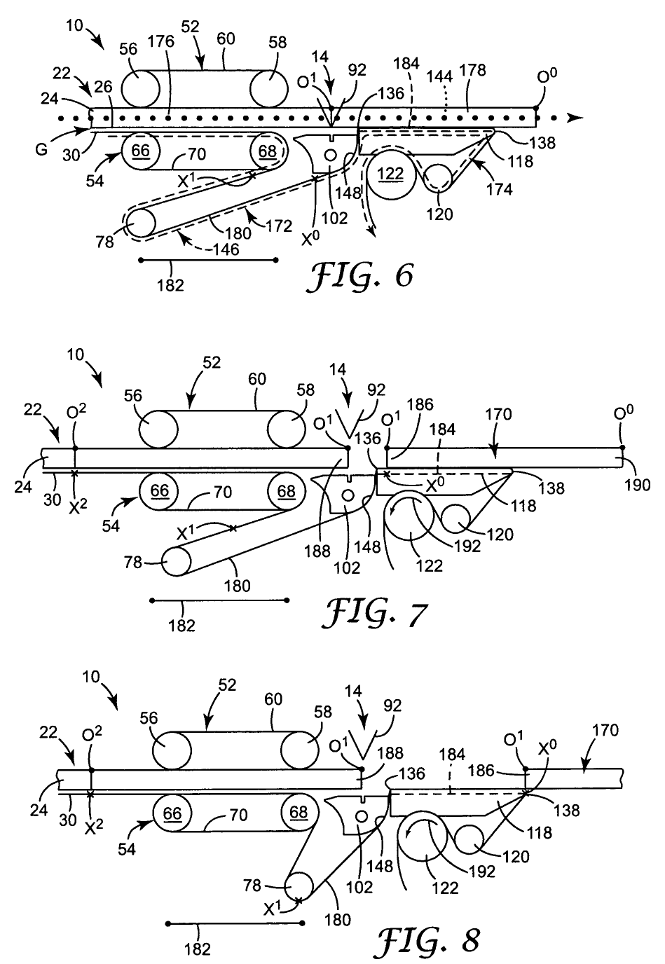

The weatherstrip 22 is fed into the applicator head 10 at the feed end 18 from a stock roll (not shown) of continuous tape-applied weatherstrip. The weatherstrip 22 advances to the cutting station 14 and the profile portion 24 of the weatherstrip 22 is cut into a segment of weatherstrip, or an individual piece. Prior to cutting the weatherstrip 22, the liner 30 is removed from the profile 24 to prevent the liner 30 from being cut as well, as discussed below with respect to FIGS. 6-13. However, after the weatherstrip 22 is cut, a portion of the removed liner 30 is reattached to the weatherstrip segment to facilitate further advancement of the weatherstrip segment. The weatherstrip segment advances to the lay down assembly 16 at the discharge end 20 of the applicator head 10 whereby the lay down assembly 16 adheres the weatherstrip segment to a substrate or a peripheral edge of an opening or body (not shown).

The robot mounting assembly 12 is attached to the free end 18 of the back plate 32 at the free end 18 of the applicator head 10 for mounting the applicator head 10 to a robot arm (not shown). The robot mounting assembly 12 includes a ring of free rollers 38, a robot mounting flange 40, and a mounting gusset 42 (shown in FIG. 4). The ring of free rollers 38 includes an opening 44 through which the weatherstrip 22 passes prior to feeding the weatherstrip 22 to the cutting station 14. The ring of free rollers 38 allows the weatherstrip 22 to be cleanly fed into the applicator head 10 despite rotation and movement of the robot arm. That is, the free rollers 38 permit a wider range of robot arm motion without binding or inhibiting the weatherstrip in-feed. The robot mounting flange 40 facilitates mounting of the applicator head 10 to the robot arm and the mounting gusset 42 reinforces the mounting of the robot mounting assembly to the back plate 32. One example of the robot mounting assembly is shown in FIGS. 1-4, however, in further embodiments of the applicator head other configurations for the robot mounting assembly are used to accommodate weatherstrip feed without inhibiting motion and rotation of the robot arm.

The weatherstrip 22 is fed into the applicator head 10 at the feed end 18, from the robot mounting assembly 12, and advances to the cutting station 14. The weatherstrip 22 passes through a guide tunnel 46 comprised of an upper guide 48 and a lower guide 50.

The guide tunnel 46 directs the weatherstrip 22 to the cutting station 14. The upper guide 48 includes a channel 48a and the lower guide 50 includes a channel 50a, whereby the channels 48a, 50a are sized to accommodate the weatherstrip 22 and position the weatherstrip 22 for advancement to the cutting station 14. In further embodiments of the guide tunnel 46, the spacing between the upper guide 48 and the lower guide 50 is variable or a guide tunnel with a different channel configuration is used to accommodate weatherstrip profiles of various sizes and configurations.

After passing through the guide tunnel 46, the weatherstrip 22 passes between an upper belt assembly 52 and a lower belt assembly 54. The upper and lower belt assemblies 52, 54 facilitate advancement of the weatherstrip 22 to the cutting station 14.

The upper belt assembly 52 includes a first upper pulley 56, a second upper pulley 58, an upper belt 60, and a first rear pulley 62 (shown in FIG. 3). The upper belt 60 encircles the first and second upper pulleys 56, 58 to form a track. The second upper pulley 58 is interconnected with the first rear pulley 62 by a shaft 63 supported by a bearing assembly 64 (shown in FIG. 3). As discussed below, the first rear pulley 62 is driven by the first servo motor 34 to rotate the second upper pulley 58 and thereby drive the upper belt 60 around the first and second upper pulleys 56, 58, which causes advancement of the weatherstrip 22 to the cutting station 14. The lower belt assembly 54 includes a first lower pulley 66, a second lower pulley 68, a lower belt 70, a liner idler assembly 72, and a second rear pulley 74 (shown in FIG. 3). The lower belt 70 encircles the first and second lower pulleys 66, 68 to form a track. The second lower pulley 68 is interconnected with the second rear pulley 74 by a shaft 75 supported by a bearing assembly 76 (shown in FIG. 3). As discussed below, the second rear pulley 74 is driven by the first servo motor 34 to rotate the second lower pulley 68 and thereby drive the lower belt 70 around the first and second lower pulleys 66, 68, which advances the weatherstrip 22 to the cutting station 14. In further embodiments of the upper and lower belt assemblies 52, 54, the upper and lower belts 60, 70 are movable apart or together to allow for weatherstrip of varying profile sizes and configurations.

Prior to the weatherstrip 22 advancing to the cutting station 14, the liner 30 is removed. The liner 30 is pulled away from the profile 24 and guided to the liner idler assembly 72, whereby the removed liner 30 is taken up and collected by a liner idler roller 78. The liner idler assembly includes the liner idler roller 78, a liner accumulator block 80, and a pair of guide rods 82a and 82b and an extension 84. The liner idler assembly 72 is positioned within an opening 86 of the back plate 32 of the applicator head 10 and is slidable along a roller path (discussed below with respect to FIGS. 6-13) between a first position (at a farthest left extent of the opening 86, as viewed in FIG. 2) and a second position (at a farthest right extent of the opening 86, as viewed in FIG. 2). The idler roller is mounted to the liner accumulator block 80. Guide rods 82a and 82b extend between opposite ends of the opening 86 to provide a path for the accumulator block 80 to slide along. The accumulator block 80 moves along first guide rod 82a. Extension 84, which in one embodiment is comprised of a pair of fingers, extends from the accumulator block 80 to the second guide rod 82b to prevent the block from rotating as it moves along first guide rod 82a. Although a two-rod guiding system is described in this embodiment, further embodiments may provide an alternate means for providing motion along a suitable path.

The movement of the liner idler assembly 72 between the first and second positions permits advancement of the weatherstrip segment to the lay down assembly 16 without advancing the weatherstrip 22 past the cutting station 14 (discussed in detail below with respect to FIGS. 6-13). Although FIG. 2 shows the liner idler assembly 72 aligned to horizontally move within the back plate 32, further embodiments of the liner idler assembly 72 may be positioned to move either vertically or in any number of directions, including a circular or other non-linear path.

After a desired length of weatherstrip 22 advances past the cutting station 14, an individual segment of weatherstrip is cut. The cutting station 14 includes an upper assembly 88 comprised of a housing 90, a cutting edge 92, and a pair of fingers 94, 96, and a lower assembly 100 comprised of an anvil 102. One example of the cutting edge 92 is a knife blade, although further embodiments of the applicator head 10 may include other cutting options, especially a cutting edge that does not result in residue build-up from the material being cut (weatherstrip and adhesive thereon). The cutting edge 92 and the fingers 94, 96 are supported by the housing 90. A finger 94, 96 is positioned on each side of the cutting edge 92. The cutting station 14 is pneumatically operated to move the cutting edge 92 and the fingers 94, 96 between a retracted position and an extended position. A solenoid valve (not shown) turns on and off, to drive the cutting edge 92 and the fingers 94, 96 between the retracted position and the extended position. In the retracted position, the cutting edge 92 and the fingers 94, 96 are a sufficient distance from an upper edge 104 (shown in FIG. 5) of the weatherstrip 22, or profile 24, to facilitate advancement of the weatherstrip 22. A lower edge 106 (shown in FIG. 5) of the weatherstrip 22 travels adjacent the anvil 102 of the cutting station 14.

As the cutting edge 92 and the fingers 94, 96 (i.e., the housing 90) move to the extended position, that is towards the weatherstrip 22, the fingers 94, 96 contact the upper edge 104 of the profile 24 before the cutting edge 92 contacts the profile 24. Fingers 94, 96 hold the weatherstrip 22 in position against the anvil 102 and relative to the cutting station 14. The cutting edge 92 continues towards the weatherstrip 22 and cuts the weatherstrip 22 to form the weatherstrip segment. In the embodiment shown in FIGS. 1 and 2, the fingers 94, 96 are spring loaded to hold the weatherstrip 22 in position while allowing the cutting edge 92 to continue towards the profile 24. The anvil 102 includes a lateral slot 108 for receiving the cutting edge 92 as the cutting edge 92 cuts the weatherstrip 22. After the weatherstrip 22 is cut, the cutting edge 92 and the fingers 94, 96 move away from the weatherstrip 22 and the anvil 102. As the cutting edge 92 retracts, the fingers 94, 96 briefly remain in contact with the weatherstrip 22, which enables constant control over the weatherstrip 22 during the cutting step at the cutting station 14 and aids in separating the cutting edge 92 from the weatherstrip 22.

After the weatherstrip segment is cut, a portion of previously removed liner 30 is reattached to the weatherstrip segment and the segment advances to the lay down assembly 16 at the discharge end 20 of the applicator head 10. However, the weatherstrip segment first passes through an exit assembly 110 comprised of an upper exit assembly 112 and a lower exit assembly 114. The upper exit assembly 112 includes a liner stick-down roller 116, which is not driven. The lower exit assembly 114 includes a liner strip block 118, a liner idler roller 120, a liner pull roller 122, a liner nip assembly 124 (comprised of a first roller 126 and a second roller 128), and a third rear pulley 130 (see FIG. 3). The liner stick-down roller 116 and the liner strip block 118 define a path for the weatherstrip segment through the exit assembly 110. As seen in FIG. 1, the stick-down roller 116 includes a channel 132 having a diameter smaller than a diameter of the roller 116 and the strip block 118 includes a channel 134 whereby the channels 132, 134 are sized to accommodate the weatherstrip segment.

The previously removed liner 30 is reattached to the weatherstrip segment at a first end 136 (shown in FIG. 2) of the strip block 118. A portion of the liner 30 remains reattached to the weatherstrip segment along a length of the strip block 118. The liner 30 is again removed from the weatherstrip segment at a second end 138 (shown in FIG. 2) of the strip block 118. The liner 30 then passes around the idler roller 120, the pull roller 122 and the first roller 126 of the nip assembly 124 before the liner 30 exits the applicator head 10. The liner pull roller 122 is interconnected to the third rear pulley 130 by a shaft 139 supported by a bearing assembly 140 (shown in FIG. 3), whereby the second servo motor 36 drives the third rear pulley 130 and the liner pull roller 122 to pull the liner 30 and thereby advance the liner 30 and the weatherstrip segment through the exit assembly 110.

The applicator head 10 shown in FIGS. 1-4 includes a vacuum take-away tube 142 for discarding of the liner 30 removed from the discharged weatherstrip segment. The vacuum take-away tube 142 either blows the liner 30 into a storage container (not shown) or into a chopper (not shown) for disposal. As shown in FIGS. 1, 2 and 4, the liner 30 is removed in a direction away from the lay down assembly 16, and in particular away from an application area 154 proximate the lay down assembly 16. In further embodiments of the applicator head 10, the liner 30 may be rewound onto a separate roller, drum or core for subsequent disposal or reuse.

The components of the applicator head 10 define two process paths from the feed end 18 to the discharge end 20, a first process path 144 (shown by the dotted line path 144 in FIG. 6) that the profile portion 24 of the weatherstrip 22 and the weatherstrip segment follow and a second process path 146 (shown in part by the dashed line path 146 in FIG. 6) that the liner 30 follows. The first process path 144 is defined by the guide tunnel 46, the upper and lower belt assemblies 52, 54, the cutting station 14, the exit assembly 110 (in particular, the stick down roller 116 and the strip block 118). The second process path 146 is coextensive with at least a portion of the first process path 144 through the guide tunnel 46 and between the upper and lower belt assemblies 52, 54. However, prior to entering the cutting station 14, the liner 30 is removed from the profile 24 and is diverted to a first section of the second process path 146. The second process path 146 travels around the liner idler roller 78, between the second roller 128 of the nip assembly 124 and a lower curved edge 148 (shown in FIG. 2) of the anvil 102. At this point the second process path 146 is reconnected with the first process path 144 through the exit assembly 110, between the stick down roller 116 and the strip block 118. Once the liner 30 is removed from the weatherstrip segment at the second end 138 of the strip block 118, the liner 30 is than diverted to a second section of the second process path 146. The liner 30 passes around the idler roller 120, the pull roller 122, and then around the first roller 126 of the nip assembly 124 before it terminates and the liner 30 eventually exits the applicator head 10.

The lay down assembly 16 includes a housing 150 and a roller 152. The housing 150 is movably attached to the back plate 32 at the discharge end 20 of the applicator head 10, and the roller 152 is mounted to the housing 150. The lay down assembly 16 is positioned adjacent an application area 154 (FIG. 2) where either door frames or doors of automotive bodies (not shown), are presented for installation of the weatherstrip segment. The lay down roller 152 rolls the weatherstrip piece against a peripheral edge of the door frame, whereby the adhesive 28 attaches the weatherstrip to the door frame. The lay down assembly 16 moves up and down with respect to the back plate 32 to position the lay down roller 152 relative to the application area 154 and to press and adhere the weatherstrip segment to the door frame. In further embodiments of the present invention, the weatherstrip segment is attached to any number of substrates, for example a refrigerator door or frame.

The first and second servo motors 34, 36 control and coordinate the feed rate of the weatherstrip 22 to the cutting station 14 and the liner removal and discharge rate of the weatherstrip segment to the lay down assembly 16. As shown in FIG. 3, each servo motor is attached to a rear face 156 of the back plate 32 by a mounting assembly 34a, 36a (which are not shown in FIG. 4 for illustrative purposes). The first servo motor 34 controls advancement of the weatherstrip 22 to the cutting station 14. The first rear pulley 62 of the upper belt assembly 52, the second rear pulley 74 of the lower belt assembly 54 and an idler pulley 157 on the rear face 156 of the back plate 32 are interconnected by a drive belt 158 (shown in FIGS. 3 and 4), which is driven by the first servo motor 34. Although not shown in FIGS. 3 and 4, the first servo motor 34 also includes a drive shaft and a pulley interconnected with the drive belt 158. The drive belt 158 driven by the first servo motor 34 operates to rotate the first and second rear pulleys 62, 74, which rotate the second upper and lower belt pulleys 58, 68 to move the upper and lower belts 60, 70 and thereby advance the weatherstrip 22 to the cutting station 14. The upper and lower belts 60 and 70 move simultaneously at the same rate.

The second servo motor 36 includes a drive shaft 160 and a pulley 162 (shown in FIG. 4). The pulley 162 of the second servo motor 36 and the third rear pulley 130 of lower exit assembly 114 are interconnected by a drive belt 164 (shown in FIGS. 3 and 4). The drive belt 164 driven by the second servo motor 36 operates to rotate the third rear pulley 130, which rotates the liner pull roller 122 to thereby advance the weatherstrip segment (with the temporarily attached liner) through the exit assembly 110 and to the lay down assembly 16. A controller (not shown) coordinates weatherstrip feed rate, movement of the cutting edge and weatherstrip segment discharge rate. That is, the controller coordinates activation of the first and second servo motors to advance the weatherstrip and the weatherstrip segment, respectively, as well as movement of the cutting edge 92 between the retracted position and the extended position. For example, a sensor detects a leading edge of the weatherstrip and its position relative to the cutting station to initiate cutting of the weatherstrip.

A vision system, which includes a camera 166 and a lens 168, is mounted to the applicator head 10 for registering the approach of a door, a door frame, or other workpiece into the application area 154. The vision system, such as the vision system manufactured by Braintech (North Vancouver, BC, Canada), provides signals to the controller that coordinates the movement of the robot and the operation of the servo motors 34, 36 based upon a workpiece's position relative to the application area 154. In further embodiments of the applicator head 10, the applicator head 10 operates independently of the vision system 166.

FIGS. 6-13 are schematic diagrams illustrating a process for applying an individual segment of weatherstrip for attaching to a substrate. Selective components from the applicator head 10 are shown in FIGS. 6-13, including the upper belt assembly 52, the lower belt assembly 54, the liner idler roller 78, the cutting edge 92, the anvil 102, the strip block 118, the static idler roller 120 and the liner pull roller 122.

The continuous weatherstrip 22 is fed into the applicator head 10 and to the cutting station 14 whereby the cutting edge 92 cuts the weatherstrip 22 to define an individual segment of weatherstrip 170 (shown in FIG. 7). The weatherstrip 22 includes the three-dimensional profile 24 having the face 26 at least partially covered with the adhesive 28 (not shown in FIGS. 6-13, but indicated by a gap G (FIG. 6) between the profile 24 and the liner 30) and the removable liner 30 attached to the adhesive face 26 (shown in FIG. 5). The three-dimensional profile 24 of the weatherstrip 22 follows the first process path 144, shown by a dotted line in FIG. 6 through the applicator head 10, and the liner 30 of the weatherstrip 22 follows the second process path 146, shown by a dashed line in FIG. 6, through the applicator head 10. The first process path 144 is defined in part by the lower belt assembly 54, the anvil 102 and the strip block 118. The second process path 146 is coextensive with portions of the first process path 144, namely the lower belt assembly 54 and the strip block 118. A first portion 172 of the second process path 146 (shown in FIG. 6) extends from the lower belt assembly 54, around the idler roller 78 and to the first end 136 of the strip block 118. The first portion 172 of the second process path 146 lengthens and shortens between a first length (shown in FIGS. 6 and 10-13) and a second length (shown in FIG. 8), which is less than the first length. A second portion 174 of the second process path 146 extends from the second end 138 of the strip block 118, around the idler roller 120, around the pull roller 122, to the discharge end 20 of the applicator head 10.

In FIG. 6, the weatherstrip 22 is advanced along the first process path 144 between the upper and lower belt assemblies 52, 54 to the cutting edge 92 of the cutting station 14. The weatherstrip 22 includes a first portion 176 upstream of the cutting station 14 and a second portion 178 downstream of the cutting edge 92. The weatherstrip 22 is advanced through the cutting station 14 until a desired length of weatherstrip is positioned downstream of the cutting edge 92.

After the weatherstrip 22 passes between the upper and lower belt assemblies 52, 54 and before the weatherstrip 22 enters the cutting station 14, the liner 30 is removed from the first portion 176 of the weatherstrip 22 to define a loop of removed liner section 180. The removed liner section 180 is diverted from the first process path 144 to the second process path 146 and taken up by the idler roller 78. The idler roller 78 is movable between a first position, at a farthest left extent of a roller path 182 (shown as path line 182 in FIGS. 6-13) defined by opening 86 (shown in FIG. 2), and a second position at a farthest right extent of the roller path 182. The position of the idler roller 78 along the roller path 182 defines a length of the first portion 172 of the second process path 146 and the length of the loop of removed liner section 180. When the idler roller 78 is in the first position, the first portion 172 of the second process path 146 and the loop of removed liner section 180 are at the first length. When the idler roller 78 is in the second position, the first portion 172 of the second process path 146 and the loop of removed liner section 180 are at the second length. In FIG. 6, the idler roller 78 is in the first position at a farthest left extent of the roller path 182, the first portion 172 of the second process path 146 has the first length and the loop of removed liner section 180 has the first length.

After the removed liner section 180 is taken up by the idler roller 78, the removed liner section continues along the first portion 172 of the second process path 146, including the curved edge 148 of the anvil 102, to the first end 136 the strip block 118. Here, portion 184 of the removed liner section 180 is attached to the second portion 178 of the weatherstrip 22 after the weatherstrip 22 exits the cutting station 14. The removed liner section 180 is attached to the adhesive face 26 of the three-dimensional profile 24 as reapplied liner section 184 using the adhesive 28 (not shown). The reapplied liner section 184 is attached to the second portion 178 of the weatherstrip 22 at the first end 136 of the strip block 118.

The reapplied liner section 184 facilitates advancement of the weatherstrip 22 through the exit assembly 110 (shown in FIGS. 1 and 2) and along the strip block 118. At the second end 138 of the strip block 118, the reapplied liner section 184 is removed from the second portion 178 of the weatherstrip 22. The removed reapplied liner section 184 passes along the second portion 174 of the second process path 146, along a path which extends around the idler roller 120 and around the driven pull roller 122 (although the pull roller is shown idled in FIG. 6) before exiting the applicator head 10.

In FIG. 6, the cutting edge 92 is in the extended position to cut the three-dimensional profile 24 and form the individual weatherstrip segment 170 of (shown in FIG. 7). The weatherstrip 22 is held in position relative to the cutting station 14 proximate a cut point O¹ located between the first portion 176 and the second portion 178 of the weatherstrip 22. As discussed above, the weatherstrip 22 is held relative to the cutting station 14 with fingers 94, 96 (shown in FIGS. 1 and 2). The cutting edge 92 cuts the weatherstrip 22, in particular the profile 24, at cut point O¹ to define the individual weatherstrip segment 170 (shown in FIG. 7).

Cut point O¹ indicates the location where the cutting edge 92 cuts the weatherstrip 22 to form the weatherstrip segment 170, which also defines a proximal end 186 of the weatherstrip segment 170 (shown in FIG. 7) and a distal end 188 of a subsequently cut weatherstrip segment, which is still a part of the weatherstrip 22. Cut point O⁰ indicates a previous cut location of the weatherstrip 22, which is also a distal end 190 of the weatherstrip segment 170 and a proximal end of a previously cut weatherstrip segment (not shown). Liner point X¹ represents a point along the removed liner section 180 initially aligned with cut point O¹ of the weatherstrip 22. Liner point X⁰ represents a point along the removed liner section initially aligned with the cut point O⁰ of the weatherstrip 22.

In FIGS. 7-9, weatherstrip segment 170 advances away from the cutting edge 92 to the lay down assembly 16 (not shown). The cutting edge 92 and the fingers 94, 96 (not shown) move away from the profile 24 to the retracted position.

The individual segment of weatherstrip 170 is advanced to the lay down assembly 16 by pulling on the reapplied liner section 184. The driven pull roller 122 rotates in a direction shown by arrow 192 (e.g., counter-clockwise) to pull the reapplied liner section 184 along the second portion 174 of the second process path 146 and away from the cutting station 14. As shown in FIGS. 7 and 8, the individual weatherstrip segment 170 is advanced by pulling the reapplied liner section 184 until the proximal end 186 of the weatherstrip segment 170 reaches the second end 138 of the strip block 118. Once the proximal end 186 of the weatherstrip segment 170 reaches the second end 138 of the strip block 118, advancement of the reapplied liner section 184 stops. During advancement of the weatherstrip segment 170 along the strip block 118, note that liner point X⁰ of the reapplied liner section 184 is aligned with cut point O¹ at the proximal end 186 of the weatherstrip segment 170 (see FIG. 7).

Although the weatherstrip segment 170 is advanced along the strip block 118 to the lay down assembly 16, the weatherstrip 22 remains held in position relative to the cutting edge 92 of the cutting station 14. During advancement of the weatherstrip segment 170 to the lay down assembly 16, the idler roller 78 moves from the first position at the farthest left extent of the roller path 182 to the second position at farthest right extent of the roller path 182. Movement of the idler roller 78 to the second position shortens the first portion 172 of the second process path 146 from the first length to the second length, and thereby shortens the loop of removed liner section 180 from the first length to the second length. The idler roller 78 lets up slack in the loop of removed liner section 180 by shortening the loop 180 and the first portion 172 of the second process path 146 to the second length. By letting up slack from the loop of removed liner section 180, the weatherstrip 22 is prevented from advancing past the cutting edge 92. When the proximal end 186 of the weatherstrip segment 170 reaches the second end 138 of the strip block 118, the idler roller 78 is in the second position along the roller path 182 (see FIG. 8).

As shown in FIG. 9, once the weatherstrip segment 170 advances past the strip block 118, the reapplied liner section 184 is rewound by reversing its direction along the second process path 146 and the idler roller 78 moves from the second position to the first position to take up slack in the loop of removed liner section 180. The pull roller 122 rotates in a direction shown by arrow 194 (e.g., clockwise) and idler roller 78 moves toward the first position at the farthest left extend of roller path 182 to move the reapplied liner section 184 in reverse along the second portion 174 of the second process path, i.e., towards the cutting station 14. Liner points X¹ and X⁰ move in reverse along the second process path 146. In addition, the first portion 176 of the weatherstrip 22 remains stopped relative to the cutting edge 92. Movement of the idler roller 78 from the second position to the first position takes up slack in the loop of removed liner section 180, lengthens the first portion 172 of the second process path 146 from the second length to the first length, and lengthens the loop of removed liner section 180 to the first length. Once the idler roller 78 reaches the first position along the roller path 182, the removed liner section 180 is in position to begin advancement of the weatherstrip 22 through the cutting station 14.

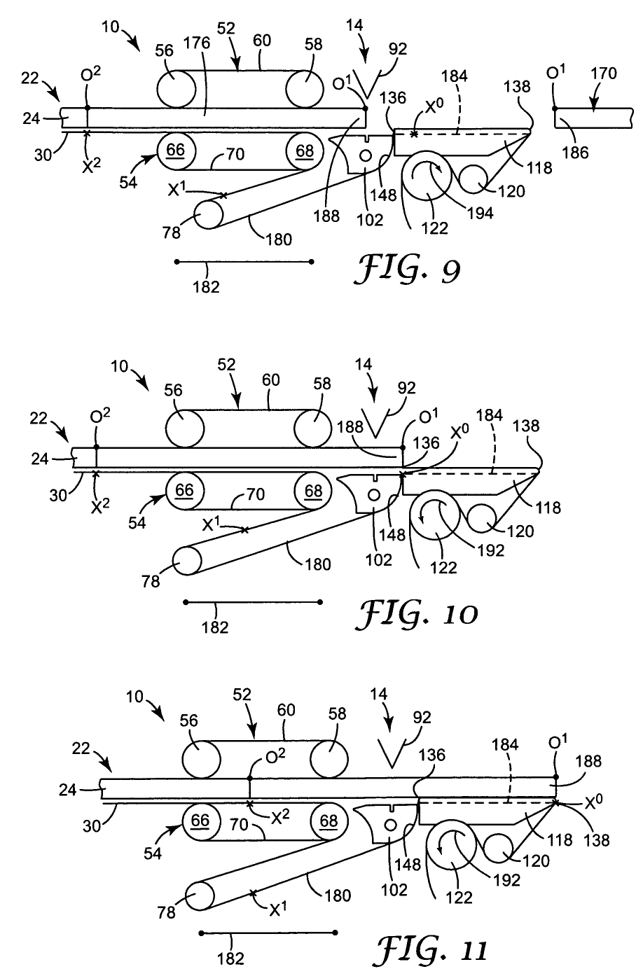

In FIGS. 10-13, the weatherstrip 22 is advanced past the cutting edge 92 to position a new portion of the weatherstrip 22 for cutting into a weatherstrip segment. The weatherstrip 22 is advanced to the cutting station by the driven upper and lower belt assemblies 52, 54 and advanced along the strip block 118 by the driven pull roller 122 (rotating in the direction shown by arrow 192, e.g., counter-clockwise). The pull roller 122 pulls the reapplied liner section 184 along the second process path 146, and thereby the weatherstrip 22 attached thereto along the strip block 118. As shown in FIGS. 10 and 11, liner point X⁰ is aligned with cut point O¹ at the distal end 188 of the weatherstrip 22. The reapplied liner section 184, including liner point X⁰, is reattached to the weatherstrip 22 and travels along the strip block 118 to advance the weatherstrip 22 through the cutting station. Once liner point X⁰ reaches the second end 138 of the strip block 118, that portion of the reapplied liner section 184 is removed from the weatherstrip 22 and diverted from the first process path 144 to the second portion 174 of the second process path 146. A cut point O² is defined along the length of the weatherstrip 22 and a liner point X² of the liner 30 is aligned with cut point O². The distance between cut point O¹ at the distal end 188 of the weatherstrip 22 and cut point O² defines an individual segment of weatherstrip for the next cut by the cutting edge 92. Once the next weatherstrip segment is cut, cut point O² will become a proximal end of the subsequently cut weatherstrip segment.

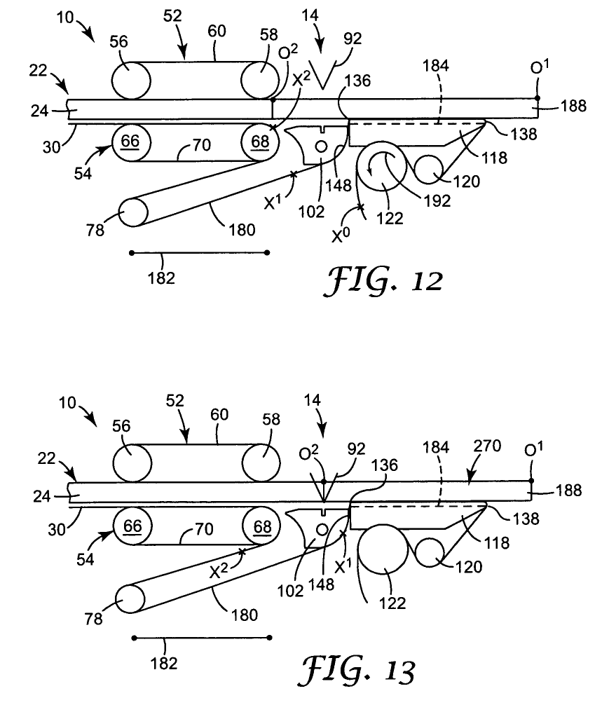

As shown in FIG. 12, the weatherstrip continues to advance past the cutting edge 92 and liner point X² remains aligned with cut point O² of the weatherstrip 22. When the liner 30 reaches the end of the lower belt assembly 54, and prior to entering the cutting station 14, the liner 30 is removed from the profile 24 of the weatherstrip 22 and diverted to the first portion 172 of the second process path 146 (as shown by liner point X² in FIG. 12).

As shown in FIG. 13, which illustrates the same step in the weatherstrip segment applying process or cycle as FIG. 6, when the cut point O² is positioned relative to the cutting edge 92, advancement of the weatherstrip 22 is stopped by discontinuing drive of the upper and lower belt assemblies 52, 54 and the pull roller 122. As discussed above with respect to FIG. 6, the weatherstrip 22 is held in position relative to the cutting edge 92 of the cutting station 14, typically by the fingers 94, 96 (not shown). The cutting edge 92 moves into the extended position to cut the weatherstrip 22 at cut point O² to define another weatherstrip segment 270.

The process of applying a weatherstrip segment is repeated multiple times to form a plurality of weatherstrip segments. FIGS. 6-12 illustrate the process steps for applying a single weatherstrip segment and FIG. 13 illustrates the reinitiation of the process to begin applying a subsequent weatherstrip segment. To form a weatherstrip segment, a length of weatherstrip is advanced to a cutting station wherein the weatherstrip includes a first portion upstream of the cutting station and a second portion downstream of the cutting station. A liner removably adhered to the weatherstrip is removed prior to the weatherstrip advancing into the cutting station to define a removed liner section. A portion of the removed liner section is attached to an adhesive face of the second portion of the weatherstrip, to thereby define a reapplied liner section.

The weatherstrip stops advancing past the cutting station when a cut point separating the first portion and the second portion of the weatherstrip is proximate the cutting station. The weatherstrip is cut by the cutting station at the cut point to define an individual segment of weatherstrip from the second portion of the weatherstrip. The distance from the cut point to a distal end of the weatherstrip defines a length of the weatherstrip segment. The weatherstrip segment is pulled, or advanced, to a lay down assembly by drawing the reapplied liner section away from the cutting station, however, the advance of the first portion of the weatherstrip remains stopped. The reapplied liner section is then removed from the weatherstrip segment.

The lay down assembly is used to adhere the weatherstrip segment to a substrate using the adhesive face. Once the weatherstrip segment is attached to the substrate, such as a vehicle door or door frame, the applicator head reinitiates the applying process by advancing the weatherstrip to the cutting station. The process is repeated until a second weatherstrip segment is formed for application to a substrate. A process cycle consists of advancing the weatherstrip to the cutting station, cutting the weatherstrip to define a weatherstrip segment, advancing the weatherstrip segment to the lay down assembly and adhering the weatherstrip segment to a substrate. In one embodiment, the cycle has a cycle time of about 50 seconds. However, those skilled in the art will realize the cycle time may be shorter or longer.

Although the present invention has been described with reference to preferred embodiments, workers skilled in the art will recognize that changes may be made in form and detail without departing from the spirit and scope of the invention. For example, rather than a continuous reel feeding of a weatherstrip to the applicator head (as discussed above), individual lengths of weatherstrip may be fed to the applicator head. In further embodiments, the applicator head may be used manually or otherwise not in connection with a robot arm.

1. A method for applying a segment of weatherstrip, the method comprising:
(a) advancing a length of weatherstrip to a cutting station wherein the weatherstrip has a three-dimensional profile having a face at least partially covered with an adhesive and a removable liner attached to the adhesive on the face, and further wherein the weatherstrip includes a first portion upstream of the cutting station and a second portion downstream of the cutting station;
(b) removing the liner from the first portion of the weatherstrip prior to the weatherstrip advancing into the cutting station to define a loop of removed liner section;
(c) attaching a portion of the removed liner section to the second portion of the weatherstrip by engaging the portion of the removed liner section to the adhesive on the face of the profile of the weatherstrip, thereby defining a reapplied liner section on the second portion of the weatherstrip;
(d) stopping the advance of the weatherstrip past the cutting station;
(e) cutting the weatherstrip at the cutting station proximate a cut point separating the first portion and the second portion of the weatherstrip to define an individual segment of weatherstrip with adhesive thereon from the second portion of the weatherstrip;
(f) drawing the reapplied liner section away from the cutting station, thereby pulling the individual segment of weatherstrip to a lay down assembly while the advance of the first portion of the weatherstrip remains stopped; and
(g) removing the reapplied liner section from the individual segment of weatherstrip.

2. The method of claim 1, and further comprising:
(h) using the lay down assembly, adhering the individual segment of weatherstrip to a substrate using the adhesive on the face.

3. The method of claim 2 wherein a cycle is comprised of steps (a) through (h).

4. The method of claim 3 wherein the cycle has a cycle time of about 50 seconds.

5. The method of claim 1, and further comprising repeating steps (a) through (g) to form a plurality of individual segments of weatherstrip.

6. The method of claim 1 wherein the cutting station includes a cutting edge movable between a retracted position to facilitate advancing the weatherstrip and an extended position for cutting the weatherstrip.

7. The method of claim 1 wherein the cutting station includes at least one finger movable between a retracted position to facilitate advancing the weatherstrip and an extended position to hold the weatherstrip in a stopped position relative to the cutting station.

8. The method of claim 1 wherein step (f) further comprises:
shortening a length of the loop of removed liner section to facilitate advancing the individual segment of weatherstrip while the advance of the first portion of the weatherstrip remains stopped.

9. The method of claim 8, and further comprising:
drawing the reapplied liner section toward the cutting station after the individual segment of weatherstrip is pulled to the lay down assembly, thereby lengthening the length of the loop of removed liner section.

10. The method of claim 8 wherein the loop of removed liner section traverses an idler roller movable between a first position and a second position, such that when the idler roller is in the first position the loop of removed liner section has a first length and when the idler roller is in the second position the loop of removed liner section has a second length less than the first length.

11. The method of claim 1, and further comprising:
discarding a portion of the reapplied liner section after the reapplied liner section is removed from the individual segment of weatherstrip.

12. A method for applying an individual segment of weatherstrip for attaching to a substrate, the method comprising:
advancing a continuous supply of weatherstrip to a cutting station wherein the weatherstrip has a three dimensional profile having a face at least partially covered with an adhesive and a removable liner attached to the adhesive on the face, wherein the three dimensional profile of the weatherstrip follows a first process path and the liner of the weatherstrip follows a second process path, which are at least in part, coextensive paths, and further wherein the second path varies in length between a first length and a second length less than the first length;
removing a section of the liner from the weatherstrip prior to the weatherstrip advancing into the cutting station, wherein the removed liner section is diverted from the first process path to the second process path, and further wherein the second process path has the first length;
using the adhesive, attaching a portion of removed liner section from the second process path to the face of the three dimensional profile in the first process path after the weatherstrip exits the cutting station, thereby defining a reapplied liner section;
holding the three dimensional profile in position relative to the cutting station;
cutting the three dimensional profile at the cutting station to define an individual segment of weatherstrip with adhesive thereon;
advancing the individual segment of weatherstrip to a lay down assembly by pulling on the reapplied liner section;
shortening the second process path of the liner from the first length to the second length while advancing the individual segment of weatherstrip to prevent the weatherstrip from exiting the cutting station; and
removing the reapplied liner section from the individual segment of weatherstrip.

13. The method of claim 12 wherein the cutting station includes a cutting edge movable between a retracted position to facilitate advancing the weatherstrip and an extended position for cutting the three dimensional profile.

14. The method of claim 12 wherein the cutting station includes at least one movable finger for holding the three dimensional profile in position relative to the cutting station.

15. The method of claim 14 wherein the finger is movable between a retracted position to facilitate advancing the weatherstrip and an extended position to hold the three dimensional profile in a stopped position relative to the cutting station.

16. The method of claim 12 wherein an idler roller movable between a first position and a second position varies the length of the second process path between the first length and the second length, such that when the idler roller is in the first position the second process path has the first length and when the idler roller is in the second position the second process path has the second length.

17. The method of claim 12, and further comprising:
lengthening the second process path of the liner from the second length to the first length after the individual segment of weatherstrip advances to the lay down assembly.

18. The method of claim 12, and further comprising:
discarding a portion of the reapplied liner section after the reapplied liner section is removed from the individual segment of weatherstrip.

19. The method of claim 18 wherein the discarding step comprises:
suctioning the reapplied liner section from the second process path through a vacuum take-away tube.

20. The method of claim 12, and further comprising:
adhering the individual segment of weatherstrip using the adhesive on the face to a substrate with the lay down assembly.
